(19) United States
(12) Patent Application Publication
(10) Pub. No.: US 2014/0327214 A1
(43) Pub. Date: Nov. 6, 2014

(54) INSTRUMENT HOLDER FOR A PLOTTER

(71) Applicant: PAZZLES, INC., KUNA, ID (US)

(72) Inventor: JEREMY SIMON VANDER WOUDE, BOISE, ID (US)

(21) Appl. No.: 14/268,238

(22) Filed: May 2, 2014

Related U.S. Application Data
(60) Provisional application No. 61/818,647, filed on May 2, 2013.

(51) Int. Cl. B23Q 1/70

(52) U.S. Cl. CPC B23Q 1/70
USPC 279/126

(57) ABSTRACT

An instrument holder for holding an instrument having a body and a tip in a plotter. The instrument holder comprising a body portion, a tensioner portion for centering the instrument within the instrument holder and for gripping the instrument, and a cap portion for allowing a user thereof to adjust the grip provided by the tensioner portion on the instrument.

### PRIORITY/CROSS-REFERENCE TO RELATED APPLICATIONS

This application claims the benefit of U.S. Provisional Application No. 61/818,647, filed 2 May 2013, the disclosure of which is incorporated by reference.

### BRIEF DESCRIPTION OF THE DRAWINGS

FIG. 1 is an upper-perspective view of a first exemplary instrument holder.

FIG. 2 is a lower-perspective view of the first exemplary instrument holder of FIG. 1.

FIG. 3 is a side-perspective view of the first exemplary instrument holder of FIG. 1, attached to a first writing instrument.

FIG. 4 is a side-perspective view of the first exemplary instrument holder of FIG. 1, attached to a second writing instrument.

FIG. 5 is an exploded view of the first exemplary instrument holder of FIG. 1.

FIG. 6 is a lower-perspective view of a first exemplary tensioner.

FIG. 7 is a top-perspective view of the first exemplary tensioner of FIG. 6.

FIG. 8 is a cross-sectional view of the first exemplary tensioner of FIG. 6.

FIG. 9 is a cross-sectional view of the first exemplary instrument holder of FIG. 1.

FIG. 10 is a cross-sectional view of the first exemplary instrument holder of FIG. 1, depicting the installation of cap portion, tensioner portion, and base portion.

FIG. 11 is a side-perspective view of the first exemplary instrument holder of FIG. 1, attached to a first instrument, depicting the attachment of tensioner portion to the first instrument.

FIG. 12 is a side-perspective view of the first exemplary instrument holder of FIG. 1, attached to a first instrument, depicting the attachment of tensioner portion to the cap portion.

### DETAILED DESCRIPTION

The following description and the referenced drawings provide illustrative examples of that which the inventor regards as his invention. As such, the embodiments discussed herein are merely exemplary in nature and are not intended to limit the scop of the invention, or its protection, in any manner. Rather, the description and illustration of these embodiments serve to enable a person of ordinary skill in the relevant art to practice the invention.

The use of “e.g.,” “etc,” “for instance,” “in example,” “for example,” and “or” and grammatically related terms indicates non-exclusive alternatives without limitation, unless the context clearly dictates otherwise. The use of “including” and grammatically related terms means “including, but not limited to,” unless the context clearly dictates otherwise. The use of the articles “a,” “an” and “the” are meant to be interpreted as referring to the singular as well as the plural, unless the context clearly dictates otherwise. Thus, for example, reference to “a jaw” includes two or more such jaws, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification and figures, are intended to take on their ordinary and customary meanings which denote approximation, unless the context clearly dictates otherwise.

The use of “plotter” and “plotting machine” means a device (e.g., die-cut machine, stand-alone printer, computer printer, cutting machine) used for printing vector graphics, cutting material, embossing material, or otherwise modifying a material or surface of material, unless the context clearly indicates otherwise. The use of “material” means any surface modifiable by a plotter, including but not limited to paper, Mylar, vinyl, fabric, plastics, metals, and composites. The use of “instrument” means a device for modifying material, including but not limited to writing instruments (e.g., pens, pencils, markers), cutting instruments, engraving instruments, and embossing instruments, unless the context clearly indicates otherwise.

Typically, a plotter will include a receiver for receiving an instrument holder therein, or will include a built in instrument holder. An instrument can then be placed into the instrument holder, and the plotter used to modify the material in the plotter with the instrument. Prior art instrument holders can comprise a plurality of set screws which can be manually individually adjusted to center the instrument within the instrument holder.

Disclosed herein are several exemplary examples of instrument holder devices (“instrument holders”), configured for receiving a wide variety of sized and shaped instruments. Some exemplary instrument holders have a number of fixed, flexible spring flanges in an upper portion which holds and centers the instrument inserted therein. In other exemplary instrument holders, the instrument holder contains a deformable insert having a passageway defined therethrough for centering the instrument. A number of different sized deformable inserts can be utilized. In each exemplary instrument holder, the instrument is generally centered for use in a plotting device. Illustrated in the attached Figures are instrument holders for use with or in a plotter, such as the cutting machine illustrated in U.S. D614,214 (Vander Woude).

Exemplary instrument holders enable a user to use a large selection of instruments (e.g, writing instruments, cutting instruments), and have them generally centered relative to the central axis of the instrument holder by simply inserting the instrument into the instrument holder and tightening the cap of the instrument holder until the instrument is secured therein.

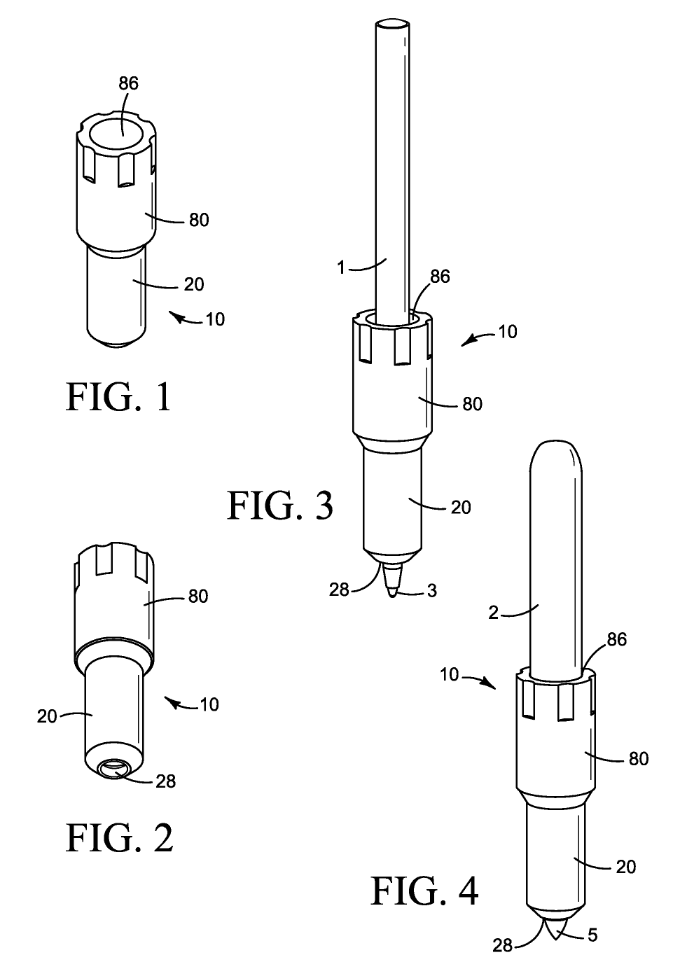

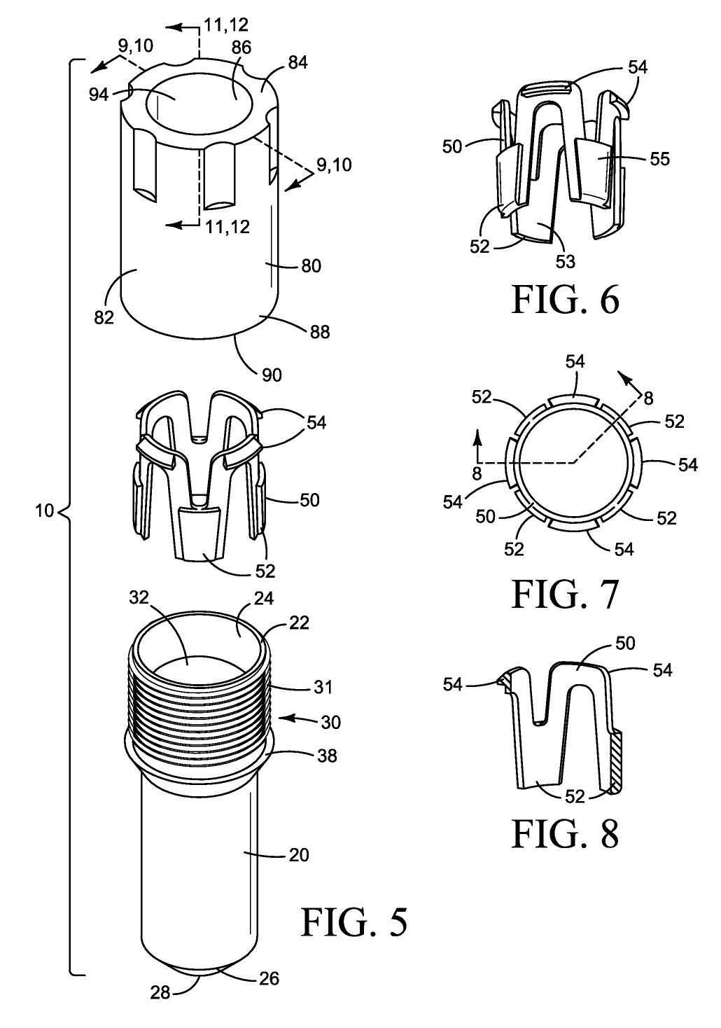

In the first exemplary instrument holder illustrated in FIGS. 1 through 13, the instrument holder 10 comprises a body portion 20, a tensioner portion 50, and a cap portion 80. The body portion 20 for supporting the instrument, the tensioner portion 50 for centering the instrument within the instrument holder 10 and gripping the instrument, and the cap portion 80 for allowing a user thereof to adjust the grip (tension provided by the tensioner portion 50) on the instrument thereby allowing the instrument holder 10 to accommodate various sizes and shapes of instruments inserted into the instrument holder 10. The instrument holder 10 is configured for use in a plotting machine, holding an instrument within said plotting machine for use in connection therewith.

FIGS. 1 and 2 show perspective views of a body portion 20 with a cap portion 80 attached thereto. The tensioner portion 50 held therein is not visible in FIGS. 1 and 2. It is preferred that the body portion 20 or other portion of the instrument holder 10 be sized and configured for insertion into or otherwise connection to a plotting machine, so that instructions sent to the plotting machine result in the instrument holder 10 being moved relative thereto. Preferably, the body portion, tensioner portion, and cap portion align along a common center axis A.

Referring now to FIG. 3, illustrated is a first instrument, namely a ball point pen 1, inserted into the instrument holder 10. The ball point pen 1 having a writing tip 3 which extends from the instrument holder 10. As can be seen by looking at the upper opening 86 of the cap portion 80, the ball point pen 1 is generally held centered within the upper opening 86. Likewise, as can be seen by looking at the lower opening 28 of the cap portion 80, the ball point pen 1 is generally held centered within the lower opening 28.

In FIG. 4, illustrated is a second instrument, namely a marker 2, inserted into the instrument holder 10 in place of the ball point pen 1 of FIG. 3. The marker 2 having a writing tip 5 which extends from the instrument holder 10. As can be seen by looking at the upper opening 86 of the cap portion 80, the marker 2 is generally held centered within the upper opening 86. Likewise, as can be seen by looking at the lower opening 28 of the cap portion 80, the marker 2 is generally held centered within the lower opening 28. This is accomplished even though the diameter of the ball point pen 1 (illustrated in FIG. 3) is smaller than the diameter of the marker 2 (illustrated in FIG. 4).

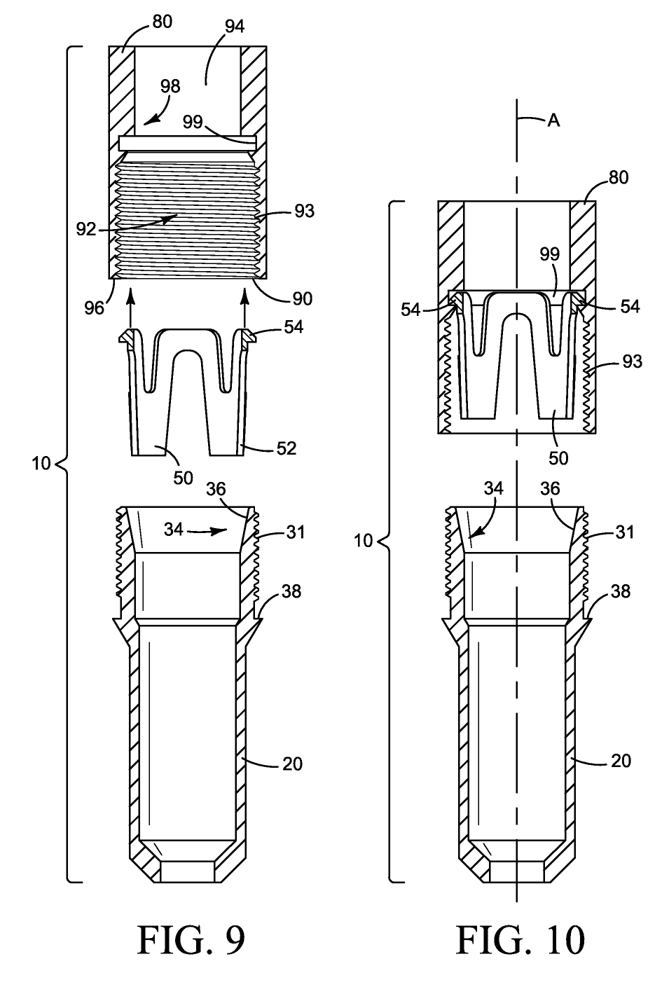

Referring now to FIGS. 5 and 9, illustrated is an exploded view of the instrument holder 10 of FIG. 1. The body portion 20 comprising a first end 22 opposing a second end 26. Defined in the first end 22 is an upper opening 24, and defined in the second end 26 is a lower opening 28. A body portion interior passageway 32 is defined through the body portion extending between the upper opening 24 and the lower opening 28.

The body portion 20 comprising a connector portion 30 configured for attachment to a cap portion 80 connector portion 92, allowing the body portion 20 to be connected to the cap portion 80. In the exemplary instrument holder illustrated in the Figures, the connector portion 30 comprises external threading 31 on the connector portion 30 which configured for mating engagement with internal threading 93 (illustrated in FIG. 9) within the cap portion 80. The external threading 31 preferably ending adjacent a stop flange 38. In such a configuration, the cap portion 80 can be screwed onto the body portion 20.

The body portion 20 further comprises a centering portion 34 for centering the instrument held therein. The centering portion 34 configured for working with the tensioner portion 50 to cause the instrument held therein to be centered. The centering portion 34 comprising a tapered outer collar 36 within said interior passageway which tapers towards the center axis A.

Illustrated in FIGS. 5, 6, 7, and 8, the tensioner portion 50 forming a collet for holding a portion of the instrument (1, 2) therein. In the exemplary tensioner portion 40 illustrated in the Figures, the tensioner portion 50 comprises a plurality of flexible jaws 52 having inside surfaces 53 configured for contacting the exterior surface of the instrument (1, 2), and tapered outside surfaces 55 configured for contacting the tapered outer collar 36 of the body portion 20. The tensioner portion 50 also comprising at least one tenon 54 configured for receipt into one or more recesses 99 defined within the cap portion 80. The tenon 54 for retaining the tensioner portion 50 within the cap portion 80.

Illustrated in FIGS. 5, 9 and 10, the cap portion 80 comprising a body 82. The body 82 has a first end 84 extending to a second end 88. An upper opening 86 is defined through the first end 84, and a lower opening 90 is defined through said second end 88. A cap portion interior passageway 94 is defined through the body 82, from the upper opening 86 to the lower opening 90. The body 82 comprising a rim 96 adjacent the lower opening 90, the rim 96 configured for bottoming out against the stop flange 38 of the body portion 20 if the cap portion 80 is fully screwed onto the body portion 20. The cap portion 80 comprising a connector portion 92 configured for mating connection with the connector portion 30 of the body portion 20. The connector portion 92 adjacent the lower opening 90, internal threading 93 configured for engagement with the external threading 31 of the body portion 20.

FIGS. 9 and 10 illustrate the insertion of the tensioner portion 50 into the cap portion 80. The tensioner portion 50 is inserted into the cap portion interior passageway 94, preferably through the lower opening 90, until the tenon(s) 54 of the tensioner portion 50 snap into the recess 99 in the cap portion 80, thereby locking the tensioner portion 50 within the cap portion, as illustrated in FIG. 10.

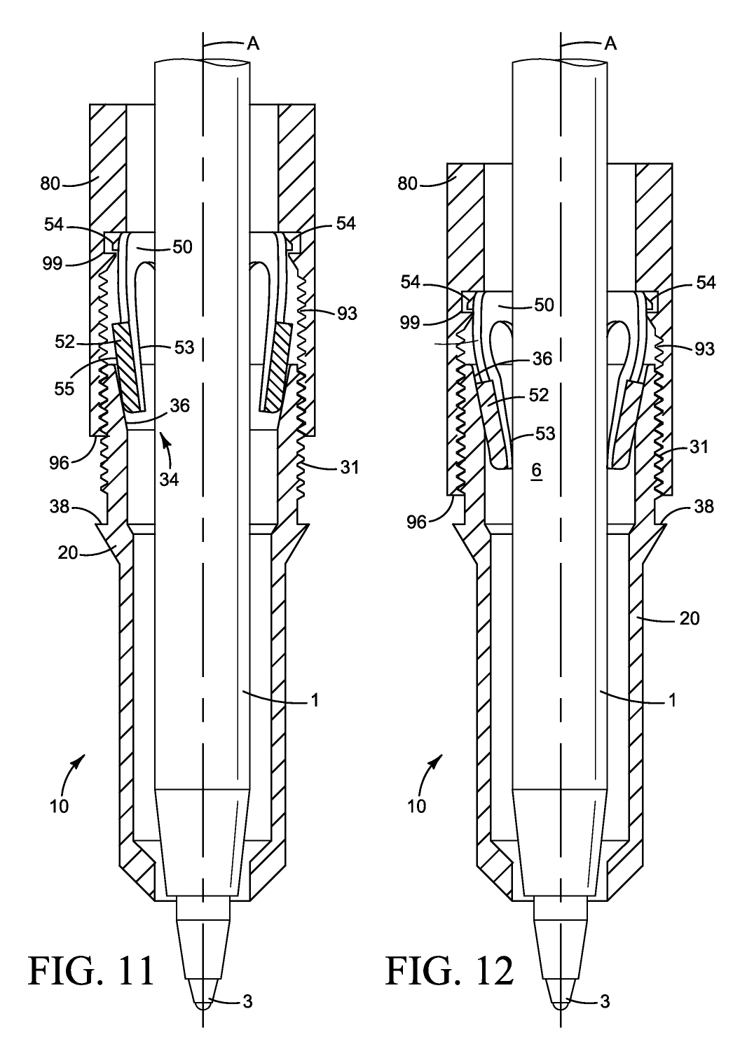

Referring now to FIGS. 11 and 12, illustrated are side-perspective views of the first exemplary instrument holder of FIG. 1, attached to a first instrument 1, depicting the attachment of tensioner portion to the first instrument 1. In these Figures, the connector portion 30 of the body portion 20 mates with the connector portion 92 of the cap portion 80, allowing the cap portion 80 to be screwed onto the body portion 20.

As the cap portion 80 is screwed onto the body portion 20, the tapered outside surfaces 55 of the flexible jaws 52 of the tensioner portion 50 are deflected inwards by contact with the tapered outer collar 36 of the body portion 20. As the flexible jaws 52 are deflected towards the center axis A, the inside surfaces 53 of the flexible jaws 52 contact the outside surface 6 of the instrument 1, clamping the instrument 1 within the instrument holder 10, and centering it therein along the central axis A. When sufficient clamping is applied to the instrument, the cap portion 80 would no longer need to be further screwed onto the body portion 20.

The instrument holder 10 thereby enables a user to easily use a large selection of instruments with a plotter, and have them centered relative to the central axis of the instrument holder by simply inserting the instrument into the instrument holder and tightening the cap until the instrument is secured.

In a second exemplary instrument holder, the cap portion and the tensioner portion are combined into one piece. In other exemplary instrument holder, the jaws comprise flanges, tangs, and/or springs.

In a third exemplary instrument holder, the instrument holder comprises a body portion, a tensioner portion for centering the instrument within the instrument holder and for gripping the instrument, and a cap portion for allowing a user thereof to adjust the grip provided by the tensioner portion on the instrument. The body portion, the tensioner portion, and the cap portion are configured to align along a common center axis.

The body portion comprises a first end opposing a second end. An upper opening is defined in the first end, and a lower opening is defined in the second end. A body portion interior passageway is defined through the body portion extending between the upper opening and the lower opening.

The body portion comprises a first connector portion. The body portion further comprises a centering portion configured for working with the tensioner portion to cause the instrument held therein to be centered along the common center axis. The tensioner portion further comprises a tensioner portion interior passageway defined therethrough.

The cap portion comprises a body, the body having a first end extending to a second end. The first end defining an upper opening therethrough, and the second end defining a lower opening therethrough. A cap portion interior passageway is defined through the body extending from the upper opening to the lower opening. The cap portion comprises a second connector portion configured for mating connection with the first connector portion.

The first connector portion is configured to be brought into mating engagement with the second connector portion, allowing the cap portion to be screwed onto the body portion. Wherein as the cap portion is screwed onto the body portion the tensioner portion applies tension to the instrument, holds the instrument within the instrument holder, and centers the instrument therein along the central axis.

The third exemplary instrument holder could optionally have none, some, or all of the optional elements, components, structures and features described in this paragraph. The first connector portion can comprise external threading, and the second connector portion can comprise internal threading configured for mating with the external threading so that the cap portion can be screwed onto the body portion. The centering portion can comprise a tapered outer collar within the interior passageway which tapers towards the center axis. The tensioner portion can comprise a plurality of flexible jaws having inside surfaces configured for contacting an exterior surface of the instrument, and tapered outside surfaces configured for contacting the tapered outer collar of the body portion. The tapered outside surfaces of the flexible jaws of the tensioner portion can be deflected inwards towards the center axis by contact with the tapered outer collar of the body portion, wherein as the flexible jaws are deflected inwards the inside surfaces of the flexible jaws contact the outside surface of the instrument. The tensioner portion can further comprise at least one tenon configured for receipt into at least one recess defined in the cap portion thereby retaining the tensioner portion within the cap portion.

In a fourth exemplary instrument holder, the instrument holder comprises a body portion, a tensioner portion for centering the instrument within the instrument holder and for gripping the instrument, and a cap portion for allowing a user thereof to adjust the grip provided by the tensioner portion on the instrument. The body portion, the tensioner portion, and the cap portion can be configured to align along a common center axis.

The body portion can comprise a first end opposing a second end, wherein an upper opening is defined in the first end, wherein a lower opening is defined in the second end, and wherein a body portion interior passageway is defined through the body portion extending between the upper opening and the lower opening.

The body portion can comprise a first means for connecting. The first means for connecting can comprise threading, mechanical fasteners, snap fits, friction fits, adhesives, magnetic connections, hinged connections, sliding connections, rotating connections, and the like.

The body portion can comprise a means for centering. The means for centering configured for working with the tensioner portion to cause the instrument held therein to be centered along the common center axis. The means for centering can comprise collets, chucks, flanges, tapers, cones, ribs, rings, inserts, and the like. The tensioner portion can further comprise a tensioner portion interior passageway defined therethrough.

The tensioner portion can further comprise means for tensioning. The means for tensioning can comprise collets, chucks, flanges, tapers, cones, ribs, rings, inserts, mechanical fasteners, snap fits, friction fits, magnetic connections, hinged connections, sliding connections, rotating connections, and the like.

The cap portion can comprise a body, the body having a first end extending to a second end, the first end defining an upper opening therethrough, and the second end defining a lower opening therethrough. A cap portion interior passageway can be defined through the body extending from the upper opening to the lower opening. The cap portion can comprise a second means for connecting configured for mating connection with the first means for connecting. The second means for connecting can comprise threading, mechanical fasteners, snap fits, friction fits, adhesives, magnetic connections, hinged connections, sliding connections, rotating connections, and the like.

The first means for connecting is configured to be brought into mating engagement with the second means for connecting, allowing the cap portion to be screwed onto the body portion. Wherein as the cap portion is screwed onto the body portion the means for tensioning applies tension to the instrument, holds the instrument within the instrument holder, and centers the instrument therein along the central axis.

The fourth exemplary instrument holder could optionally have none, some, or all of the optional elements, components, structures and features described in this paragraph. The first means for connecting can comprise external threading, and the second means for connecting can comprise internal threading configured for mating with the external threading so that the cap portion can be screwed onto the body portion. The means for centering can comprise a tapered outer collar within the interior passageway which tapers towards the center axis. The means for tensioning can comprise a plurality of flexible jaws having inside surfaces configured for contacting an exterior surface of the instrument, and tapered outside surfaces configured for contacting the tapered outer collar of the body portion. The tapered outside surfaces of the flexible jaws of the means for tensioning can be deflected inwards towards the center axis by contact with the tapered outer collar of the body portion, wherein as the flexible jaws are deflected inwards the inside surfaces of the flexible jaws contact the outside surface of the instrument. The tensioner portion can further comprise at least one tenon configured for receipt into at least one recess defined in the cap portion thereby retaining the tensioner portion within the cap portion.

A skilled artisan will be able to select an appropriate structure and material for the components in an exemplary instrument holder based on various considerations, including the intended use of the instrument holder, the intended arena within which the instrument holder will be used, and the equipment and/or accessories with which the instrument holder is intended to be used, among other considerations. It is envisioned that in some exemplary instrument holders, the tensioner portion will comprise material with the capability of flexing while retaining its shape, including but not limited to polypropylene, and ABS. The other components could be made of the same material, of another type of plastic, of a metal, of a composite, or of an organic material such as wood.

It is noted that all structure and features of the various described and illustrated embodiments can be combined in any suitable configuration for inclusion in an instrument holder according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. An instrument holder for holding an instrument having a body and a tip in a plotter, the instrument holder comprising:
a body portion, a tensioner portion for centering the instrument within the instrument holder and for gripping the instrument, and a cap portion for allowing a user thereof to adjust the grip provided by the tensioner portion on the instrument;
wherein said body portion, said tensioner portion, and said cap portion align along a common center axis;
wherein said body portion comprises a first end opposing a second end, wherein an upper opening is defined in said first end, wherein a lower opening is defined in said second end, and wherein a body portion interior passageway is defined through the body portion extending between the upper opening and the lower opening;
wherein said body portion comprises a first connector portion;
wherein said body portion comprises a centering portion configured for working with said tensioner portion to cause the instrument held therein to be centered along said common center axis;
wherein said tensioner portion further comprises a tensioner portion interior passageway defined therethrough;
wherein said cap portion comprises a body, said body having a first end extending to a second end, said first end defining an upper opening therethrough, said second end defining a lower opening therethrough, wherein a cap portion interior passageway is defined through said body extending from said upper opening to said lower opening;
wherein said cap portion comprises a second connector portion configured for mating connection with said first connector portion; and
wherein said first connector portion is configured to be brought into mating engagement with said second connector portion, allowing said cap portion to be screwed onto said body portion, wherein as said cap portion is screwed onto said body portion said tensioner portion applies tension to said instrument, holds said instrument within said instrument holder, and centers said instrument therein along said center axis.

2. The instrument holder of claim 1, wherein said first connector portion comprises external threading, wherein said second connector portion comprises internal threading configured for mating with said external threading so that the cap portion can be screwed onto the body portion.

3. The instrument holder of claim 1, wherein said centering portion comprises a tapered outer collar within said interior passageway which tapers towards said center axis.

4. The instrument holder of claim 3, wherein said tensioner portion comprises a plurality of flexible jaws, said flexible jaws comprising inside surfaces configured for contacting an exterior surface of the instrument, and tapered outside surfaces configured for contacting said tapered outer collar of said body portion.

5. The instrument holder of claim 4, wherein said tapered outside surfaces of said flexible jaws of said tensioner portion are deflected inwards towards said center axis by contact with said tapered outer collar of the body portion, and wherein as said flexible jaws are deflected inwards said inside surfaces of said flexible jaws contact said outside surface of the instrument.

6. The instrument holder of claim 5, wherein said first connector portion comprises external threading, wherein said second connector portion comprises internal threading configured for mating with said external threading so that the cap portion can be screwed onto the body portion.

7. The instrument holder of claim 6, wherein said tensioner portion further comprises at least one tenon configured for receipt into at least one recess defined in said cap portion thereby retaining said tensioner portion within said cap portion.

8. The instrument holder of claim 1, wherein said centering portion comprises a tapered outer collar within said interior passageway which tapers towards said center axis, and wherein said tensioner portion comprises a plurality of flexible jaws having inside surfaces configured for contacting an exterior surface of the instrument, and tapered outside surfaces configured for contacting said tapered outer collar of said body portion, and wherein said tapered outside surfaces of said flexible jaws of said tensioner portion are deflected inwards towards said center axis by contact with said tapered outer collar of the body portion, and wherein as said flexible jaws are deflected inwards said inside surfaces of said flexible jaws contact said outside surface of the instrument.

9. The instrument holder of claim 1, wherein said tensioner portion further comprises at least one tenon configured for receipt into at least one recess defined in said cap portion thereby retaining said tensioner portion within said cap portion.

10. An instrument holder for holding an instrument having a body and a tip in a plotter, the instrument holder comprising:
a body portion, a tensioner portion for centering the instrument within the instrument holder and for gripping the instrument, and a cap portion for allowing a user thereof to adjust the grip provided by the tensioner portion on the instrument;
wherein said body portion, said tensioner portion, and said cap portion align along a common center axis;
wherein said body portion comprises a first end opposing a second end, wherein an upper opening is defined in said first end, wherein a lower opening is defined in said second end, and wherein a body portion interior passageway is defined through the body portion extending between the upper opening and the lower opening;
wherein said body portion comprises a first means for connecting;
wherein said body portion comprises a means for centering, said means for centering configured for working with said tensioner portion to cause the instrument held therein to be centered along said common center axis;
wherein said tensioner portion further comprises a tensioner portion interior passageway defined therethrough, wherein said tensioner portion further comprises means for tensioning;
wherein said cap portion comprises a body, said body having a first end extending to a second end, said first end defining an upper opening therethrough, said second end defining a lower opening therethrough, wherein a cap portion interior passageway is defined through said body extending from said upper opening to said lower opening;
wherein said cap portion comprises a second means for connecting configured for mating connection with said first means for connecting; and
wherein said first means for connecting is configured to be brought into mating engagement with said second means for connecting, allowing said cap portion to be screwed onto said body portion, wherein as said cap portion is screwed onto said body portion said means for tensioning applies tension to said instrument, holds said instrument within said instrument holder, and centers said instrument therein along said center axis.

11. The instrument holder of claim 10, wherein said first means for connecting comprises external threading, wherein said second means for connecting comprises internal threading configured for mating with said external threading so that the cap portion can be screwed onto the body portion.

12. The instrument holder of claim 10, wherein the means for centering comprises a tapered outer collar within said interior passageway which tapers towards said center axis.

13. The instrument holder of claim 12, wherein said means for tensioning comprises a plurality of flexible jaws having inside surfaces configured for contacting an exterior surface of the instrument, and tapered outside surfaces configured for contacting said tapered outer collar of said body portion.

14. The instrument holder of claim 13, wherein said tapered outside surfaces of said flexible jaws of said means for tensioning are deflected inwards towards said center axis by contact with said tapered outer collar of the body portion, and wherein as said flexible jaws are deflected inwards said inside surfaces of said flexible jaws contact said outside surface of the instrument.

15. The instrument holder of claim 14, wherein said first means for connecting comprises external threading, wherein said second means for connecting comprises internal threading configured for mating with said external threading so that the cap portion can be screwed onto the body portion.

16. The instrument holder of claim 15, wherein said tensioner portion further comprises at least one tenon configured for receipt into at least one recess defined in said cap portion thereby retaining said tensioner portion within said cap portion.

17. The instrument holder of claim 10, wherein said means for centering comprises a tapered outer collar within said interior passageway which tapers towards said center axis, and wherein means for tensioning comprises a plurality of flexible jaws having inside surfaces configured for contacting an exterior surface of the instrument, and tapered outside surfaces configured for contacting said tapered outer collar of said body portion, and wherein said tapered outside surfaces of said flexible jaws of said means for tensioning are deflected inwards towards said center axis by contact with said tapered outer collar of the body portion, and wherein as said flexible jaws are deflected inwards said inside surfaces of said flexible jaws contact said outside surface of the instrument.

18. The instrument holder of claim 10, wherein said tensioner portion further comprises at least one tenon configured for receipt into at least one recess defined in said cap portion thereby retaining said tensioner portion within said cap portion.

19. An instrument holder for holding an instrument having a body and a tip in a plotter, the instrument holder comprising:
a body portion, a tensioner portion for centering the instrument within the instrument holder and for gripping the instrument, and a cap portion for allowing a user thereof to adjust the grip provided by the tensioner portion on the instrument, wherein said body portion, said tensioner portion, and said cap portion align along a common center axis;
wherein said body portion comprises a first end opposing a second end, wherein an upper opening is defined in said first end, wherein a lower opening is defined in said second end, and wherein an interior passageway is defined through the body portion extending between the upper opening and the lower opening;
wherein said body portion comprises a first connector portion;
wherein said body portion comprises a centering portion configured for working with said tensioner portion to cause the instrument held therein to be centered along said common center axis, said centering portion comprises a tapered outer collar within said interior passageway which tapers towards said center axis;
wherein said tensioner portion comprises a plurality of flexible jaws having inside surfaces configured for contacting an exterior surface of the instrument, and tapered outside surfaces configured for contacting said tapered outer collar of said body portion;
wherein said tensioner portion further comprising at least one tenon configured for receipt into at least one recess defined in said cap portion thereby retaining said tensioner portion within said cap portion;
wherein said cap portion comprises a body, said body having a first end extending to a second end, said first end defining an upper opening therethrough, said second end defining a lower opening therethrough, wherein an interior passageway is defined through said body extending from said upper opening to said lower opening;
wherein said cap portion comprises a second connector portion configured for mating connection with said first connector portion; and
wherein said first connector portion is configured to be brought into mating engagement with said second connector portion, allowing said cap portion to be screwed onto said body portion, wherein as said cap portion is screwed onto said body portion, said tapered outside surfaces of said flexible jaws of said tensioner portion are deflected inwards towards said center axis by contact with said tapered outer collar of the body portion, and wherein as said flexible jaws are deflected inwards said inside surfaces of said flexible jaws contact said outside surface of the instrument, applying tension to said instrument and holding said instrument within said instrument holder, and centering said instrument therein along said center axis.

20. The instrument holder of claim 19, wherein said first connector portion comprises external threading, wherein said second connector portion comprises internal threading configured for mating with said external threading so that said cap portion can be screwed onto said body portion.
